(19) United States
(12) Patent Application Publication
(10) Pub. No.: US 2006/0029801 A1
(43) Pub. Date: Feb. 9, 2006

(54) Method for making a coated powder for reducing evaporative water loss

(76) Inventor: Robert O'Brien, Victoria (CA)

Correspondence Address: DORSEY & WHITNEY LLP, 555 CALIFORNIA STREET, SUITE 1000, SUITE 1000, SAN FRANCISCO, CA, 94104, US

(21) Appl. No.: 10/910,950

(22) Filed: Aug. 3, 2004

(51) Int. Cl. B05D 7/00; B32B 5/16

(52) U.S. Cl. 428/403; 427/212

(57) ABSTRACT

The present invention provides methods for making evaporation suppressing monolayers. More specifically, the present invention provides methods for making a coated powder suitable for dispersing onto the surface of a body of water as an evaporation suppressing monolayer. The coated powder is safely made by mixing amphiphilic compounds with powder particles of ionic compounds under mild conditions in good yield.

### 1. FIELD

The present invention relates generally to methods for making evaporation suppressing monolayers. More specifically, the present invention relates to methods for making a coated powder suitable for dispersing onto the surface of a body of water as an evaporation suppressing monolayer. The coated powder may be made by mixing amphiphilic compounds with powder particles of ionic compounds under mild conditions.

### 2. BACKGROUND

Application of compounds and/or mixtures of compounds that suppress evaporation on bodies of water is a possible means of water conservation and may alleviate or prevent drought. Generally, compounds that reduce water evaporation are amphiphilic and form thin films (i.e., evaporation retardant monolayers) on the surface of body of standing or flowing water (see e.g., Gaines, “Insoluble Monolayers at Liquid-Gas Interfaces,” Interscience Publishers, New York, 1966; LaMer, “Retardation of Evaporation by Monolayers,” Academic Press (New York 1962).

Fatty alcohols (Roberts, U.S. Pat. No. 3,205,059), fatty alcohols with a saccharide carrier (Myers, U.S. Pat. No. 3,391,987), fatty alcohols with a heterocyclic spreading agent (Egan et al., U.S. Pat. No. 3,415,614) and fatty alcohols with water soluble polyethylene glycols (U.S. Pat. No. 4,250,140) are some of the compounds or mixtures thereof which have been used as evaporation retardants.

Coated powders of fatty alcohols and/or analogs thereof and calcium containing materials (e.g., lime or gypsum) are also effective evaporation retardants, which are readily dispersible on bodies of water (O'Brien, U.S. Pat. No. 6,303,133; O'Brien, U.S. patent application Ser. No. 2001/0022355 A1). However, existing methods for the preparation of these coated powders, particularly as stable batches not susceptible to spontaneous oxidative degradation, are inadequate. Accordingly, what is needed are new methods for preparing coated powder evaporation retardants. These new methods, ideally, may reproducibly provide commercial scale batches of these evaporation retardants that are not susceptible to spontaneous oxidative degradation.

### 3. SUMMARY

The present invention satisfies these and other needs by providing methods for making coated powders that are evaporation retardants in stable commercial-scale batches. The new methods provide coated powders, which are not prone to spontaneous oxidative degradation reproducibly and in superior yield.

In one aspect, the present invention provides a method for making a coated powder suitable for dispersing onto the surface of a body of water as an evaporation suppressing monolayer. One or more compound(s) according to structural Formula (I): R¹—Y (I) (R¹ is (C₁₂-C₂₄) alkanyl and Y is selected from the group consisting of —OH, —C(O)H, —CONH₂, —CO₂H, —NH₂ and —S(O)₃H), at a temperature between about 30° C. above the glass transition point of the compound(s) and about 5° C. over the glass transition point of the compound(s), are mixed with powder particles of one or more ionic compound(s). The powder particles are coated with a layer of the compound(s) where the bulk temperature of the mixture is less than about 20° C. above the glass transition point of the compound(s). The layered powder particles are then cooled to a bulk temperature of less than about 15° C. below the glass transition point of the compound(s).

In another aspect, the present invention provides another method for making a coated powder suitable for dispersing onto the surface of a body of water as an evaporation suppressing monolayer. A mixture of about 9 parts of stearyl alcohol to about 1 part of cetyl alcohol on a weight by weight basis at about 80° C. is mixed with powder particles of Ca(OH)₂. The powder particles are coated with a layer of the mixture of stearyl alcohol and cetyl alcohol where the bulk temperature of the mixture is less than about 80° C. The layered powder particles are cooled to a bulk temperature of less than about 42° C.

In still another aspect, the present invention provides still another method for making a coated powder suitable for dispersing onto the surface of a body of water as an evaporation suppressing monolayer. A mixture of about 9 parts of stearyl alcohol to about 1 part of cetyl alcohol on a weight by weight basis at about 75° C. is mixed with powder particles of Ca(OH)₂. The powder particles are coated with a layer of the mixture of stearyl alcohol and cetyl alcohol where the bulk temperature of the mixture is less than about 75° C. The layered powder particles are cooled to a bulk temperature of less than about 42° C.

In still another aspect, the present invention provides a coated powder suitable for dispersing onto the surface of a body of water as an evaporation suppressing monolayer. The coated powder is made mixing one or more compound(s) according to structural Formula (I): R¹—Y (I) (R¹ is (C₁₂-C₂₄) alkanyl and Y is selected from the group consisting of —OH, —C(O)H, —CONH₂, —CO₂H, —NH₂ and —S(O)₃H), at a temperature between about 30° C. above the glass transition point of the compound(s) and about 5° C. over the glass transition point of the compound(s), with powder particles of one or more ionic compound(s). The powder particles are coated with a layer of the compound(s )where the bulk temperature of the mixture is less than about 20° C. above the glass transition point of the compound(s). The layered powder particles are cooled to a bulk temperature of less than about 15° C. below the glass transition point of the compound(s).

In still another aspect, the present invention provides a coated powder suitable for dispersing onto the surface of a body of water as an evaporation suppressing monolayer. The powder is a mixture of about 9 parts of stearyl alcohol to about 1 part of cetyl alcohol to about 90 parts of Ca(OH)₂ on a weight basis.

### 4. DETAILED DESCRIPTION

4.1 Definitions

“Alkyl” by itself or as part of another substituent refers to a saturated or branched, straight-chain or cyclic monovalent hydrocarbon radical having the stated number of carbon atoms (i.e., C1-C6 means one to six carbon atoms) that is derived by the removal of one hydrogen atom from a single carbon atom of a parent alkane, alkene or alkyne. Typical alkyl groups include, but are not limited to, methyl; ethyls such as ethanyl, ethenyl, ethynyl; propyls such as propan-1-yl, propan-2-yl, cyclopropan-1-yl, prop-1-en-1-yl, prop-1-en-2-yl, prop-2-en-1-yl, cycloprop-1-en-1-yl; cycloprop-2-en-1-yl, prop-1-yn-1-yl, prop-2-yn-1-yl, etc.; butyls such as butan-1-yl, butan-2-yl, 2-methyl-propan-1-yl, 2-methyl-propan-2-yl, cyclobutan-1-yl, but-1-en-1-yl, but-1-en-2-yl, 2-methyl-prop-1-en-1-yl, but-2-en-1-yl, but-2-en-2-yl, buta-1,3-dien-1-yl, buta-1,3-dien-2-yl, cyclobut-1-en-1-yl, cyclobut-1-en-3-yl, cyclobuta-1,3-dien-1-yl, but-1-yn-1-yl, but-1-yn-3-yl, but-3-yn-1-yl, etc.; and the like. Where specific levels of saturation are intended, the nomenclature “alkanyl,” “alkenyl” and/or “alkynyl” is used, as defined below. “Lower alkyl” refers to alkyl groups having from 1 to 6 carbon atoms.

“Alkanyl” by itself or as part of another substituent refers to a saturated branched, straight-chain or cyclic alkyl derived by the removal of one hydrogen atom from a single carbon atom of a parent alkane. Typical alkanyl groups include, but are not limited to, methanyl; ethanyl; propanyls such as propan-1-yl, propan-2-yl (isopropyl), cyclopropan-1-yl, etc.; butanyls such as butan-1-yl, butan-2-yl (sec-butyl), 2-methyl-propan-1-yl (isobutyl), 2-methyl-propan-2-yl (t-butyl), cyclobutan-1-yl, etc.; and the like.

“Glass transition point” refers to a psuedo-solid state near the melting point of the R¹—Y compound when the powder particles are encapsulated by a long hydrophobic chain (i.e., R¹) of the compound.

4.2 Methods for Making Coated Powders Useful as Evaporation Retardants

In one aspect, the present invention provides methods for making a coated powder suitable for dispersing onto the surface of a body of water as an evaporation suppressing monolayer. One or more compounds according to structural Formula (I):
R¹—Y (I)
are mixed at a temperature between about 30° C. above the glass transition point of the compound(s) and about 5° C. over the glass transition point of the compound(s) with powder particles of one or more ionic compound(s). The powder particles are coated with a layer of the compound(s) where the bulk temperature of the mixture is less than about 20° C. above the glass transition point of the compound(s). Finally, the mixture including layered powder particles are cooled to a bulk temperature of less than about 15° C. below the glass transition point of the compound(s). Here, R¹ (C₁₂-C₂₄) alkanyl and Y is selected from the group consisting of —OH, —C(O)H, —CONH₂, —CO₂H, —NH₂ and —S(O)₃H. In some embodiments, continuous processes such as one employing a fluidized bed is used to simultaneously accomplish both the mixing and cooling steps of the current invention.

In general, compounds that form evaporation retardant monolayers such as compounds of structural formula (I), are amphiphilic molecules, which typically contain both hydrophilic groups and hydrophobic regions. Common hydrophilic groups include, but are not limited to, acyl groups, amines, amine salts, hydroxyls, carboxylic acid, carboxylic acid salts, ketones, aldehydes, ethers, thiols, esters, amides, sulfonates, and halogens (e.g., fluoro, chloro, bromo, and iodo). Hydrophobic regions are typically hydrocarbon chains of twelve or more carbon atoms.

In some embodiments, Y is selected from the group consisting of —OH, —CO₂H, —NH₂ and —S(O)₃H. In other embodiments, Y is —OH or —CO₂H. In still other embodiments, Y is —OH.

In some embodiments, R¹ is (C₁₆-C₂₀) alkanyl. In other embodiments, R¹ is (C₁₆-C₂₀) alkanyl and Y is —OH or —CO₂H. Preferably, in these embodiments, R¹ is CH₃(CH₂)₁₁—, CH₃(CH₂)₁₂—, CH₃(CH₂)₁₃—, CH₃(CH₂)₁₄—, CH₃(CH₂)₁₅—, CH₃(CH₂)₁₆—, CH₃(CH₂)₁₇—, CH₃(CH₂)₁₈—, CH₃(CH₂)₁₉—, CH₃(CH₂)₂₀— or CH₃(CH₂)₂₁—, more preferably, R¹ is CH₃(CH₂)₁₅—, CH₃(CH₂)₁₆—, CH₃(CH₂)₁₇—, CH₃(CH₂)₁₈— or CH₃(CH₂)₁₉—.

In still other embodiments, the compounds of structural Formula (I) are cetyl alcohol, stearyl alcohol or mixtures thereof. In still other embodiments, the compounds of structural Formula (I) are a mixture of cetyl alcohol and stearyl alcohol. Preferably, the proportion of stearyl alcohol to cetyl alcohol is between about 20:1 and about 1:20, between about 10:1 and about 1:10, between about 5:1 and about 1:5 or between about 2:1 and about 1:2 on a weight basis. More preferably, the proportion of stearyl alcohol to cetyl alcohol is about 9:1 or about 1:1 on a weight basis. Since the specific gravity of cetyl alcohol and stearyl alcohol is essentially identical those of skill in the art will appreciate that, in this situation, a volume basis is essentially identical to a weight basis.

In some embodiments, the powder particles are an alkaline earth hydroxide, Mg(OH)₂, Ca(OH)₂, Ba(OH)₂, acidified gypsum or mixtures thereof. In other embodiments, the powder particles are Ca(OH)₂ or acidified gypsum. In still other embodiments, the powder particles are Ca(OH)₂.

In some embodiments, an extender material is also mixed with the one or more compound(s) according to structural Formula (I) and the powder particles of ionic compound(s). In other embodiments, the extender material is sand, microspheres or glass beads. In still other embodiments, the extender material is sand, microspheres or glass beads and the ionic compounds are Ca(OH)₂ or acidified gypsum.

In some embodiments, surfactants and carbohydrates (preferably, saccharides) are mixed with one or the one or more compounds according to structural Formula (I) and the powder particles of ionic compound(s). Preferably, the ionic compound(s) are Ca(OH)₂ or acidified gypsum, more preferably, Ca(OH)₂.

In some embodiments, R¹ is (C₁₆-C₂₀) alkanyl and the powder particles of ionic compound(s) are Ca(OH)₂ or acidified gypsum. In other embodiments, R¹ is (C₁₆-C₂₀) alkanyl, Y is —OH or —CO₂H and the powder particles are Ca(OH)₂. Preferably, in these embodiments, R¹ is CH₃(CH₂)₁₁—, CH₃(CH₂)₁₂—, CH₃(CH₂)₁₃—, CH₃(CH₂)₁₄—, CH₃(CH₂)₁₅—, CH₃(CH₂)₁₆—, CH₃(CH₂)₁₇—, CH₃(CH₂)₁₈—, CH₃(CH₂)₁₉—, CH₃(CH₂)₂₀— or CH₃(CH₂)₂₁—, more preferably, R¹ is CH₃(CH₂)₁₅—, CH₃(CH₂)₁₆—, CH₃(CH₂)₁₇—, CH₃(CH₂)₁₈— or CH₃(CH₂)₁₉—., even more preferably, CH₃(CH₂)₁₆— or CH₃(CH₂)₁₈—. In some of the above embodiments, an extender is included. Preferably, the extender material is sand, microspheres or glass beads. In some of the above embodiments, surfactants and carbohydrates (preferably, saccharides) are also included.

In some embodiments, the ratio of extender material to the one or more compound(s) of structural Formula (I) is between about 1:20 and about 1:1 or between about 1:10 and about 1:5 on a weight basis. In other embodiments, the ratio of the one or more compound(s) of structural Formula (I) to the powder particles is between about 1:20 and about 1:1 or between about 1:10 and about 1:5 on a weight basis.

The compound(s) should be at a temperature between less than about 30° C. above their glass transition point and about 5° C. above their glass transition point in the mixing step. In some embodiments, the compound(s) are at a temperature between about 25° C. above their glass transition point and about 5° C. over their glass transition point in the mixing step. In other embodiments, the compound(s) are at a temperature between about 20° C. above their glass transition point and about 5° C. over their glass transition point in the mixing step. In general, the compound(s) should be at the lowest possible temperature compatible with facile formation of the coated powder in good yield.

The compound(s) of structural Formula (I) may be mixed with ionic compound(s) by any method known in the art such as, for example, stirring, blending, heating, shaking, agitating, sonicating, vortexing, centrifugating, etc. Mixing should be thorough, but preferably, should take place without high shearing that causes localized heat at the point of shear. Further, formation of small particles is disfavored because of ensuing difficulties in processing.

Heat may be applied during mixing but usually the compound(s) of structural Formula (I) and the ionic compound(s) are mixed at rate that maintains the bulk temperature of the mixture at a temperature less than about 20° C. above the glass transition point of the compound(s). In some embodiments, the bulk temperature of the mixture is between about 5° C. above the glass transition point of the compound(s) and about 20° C. above the glass transition point of the compound(s).

While not wishing to be bound by theory, the vapor pressure of compounds of structural Formula (I) may be elevated after formation of the mixture including layered powder particles. It is believed that powder particles of ionic compounds may be coated with compounds of structural Formula (I), which are in a glassy amorphous state. The increased vapor pressure of compounds of structural Formula (I) may substantially increase the rate of degradation of the mixture including layered powder particles. Accordingly, rapid cooling of the mixture including layered powder particles to temperatures below the glass transition point, may prevent evaporation of compounds of structural Formula (I) and hence reduce the rate of degradation of the mixture including layered powder particles.

In general, the mixture including layered powder particles is cooled to a bulk temperature less than about 15° C. below the glass transition point temperature of the compound(s). In some embodiments, the bulk temperature of the mixture including layered powder particles is less than about 35° C. In other embodiments, the bulk temperature of the mixture including layered powder particles is less than about 25° C. Cooling of the mixture including layered powder particles should take place immediately after mixing of compound(s) of Formula (I) and ionic compound(s) is completed, preferably, using active cooling techniques, infra. Maintenance of the mixture including layered powder particles above about 15° C. below the glass transition point temperature of the compound(s) may have detrimental effects on product quality. Accordingly, cooling of the mixture should take place rapidly in the smallest possible amount of time. In some embodiments, the mixture including layered powder particles is cooled to a temperature less than about 15° C. below the glass transition point temperature of the compound(s) in less than about sixty minutes. In other embodiments, the mixture including layered powder particles is cooled to a temperature less than about 15° C. below the glass transition point temperature of the compound(s) in less than about thirty minutes.

For example, one simple active cooling technique for free flowing powders is providing an open or closed chute or tray area. Here, the powder is spread thinly enough to radiate heat to the surrounding atmosphere while being moved to the packaging station. Accordingly, powder arrives at the packaging station at a temperature below the decomposition point of the mixture. Another method entails switching the jacket fluid of the reactor to cold from hot with mixing continued until the temperature of the powder is below the decomposition point. Still another method is a fluidized bed procedure where the powder is heated and mixed and then cooled in a continuous process in a single complex vessel. For example, the cooling portion of the vessel could have systems such as conducting walls with a chilled water jacket, cold inert gas injectors, a hollow water or oil cooled transfer screw or such other mechanisms known in the art. Yet another method uses a separate stage that incorporated techniques from fluidized bed systems or other continuous processes, which can be optionally combined with thinly spreading powder to eliminate heat at a rapid pace. Other active cooling techniques are well within the ambit of those of skill in the art.

In some embodiments, the mixing and cooling steps are continuous. For example, a fluidized bed process, supra, may provide continuous active cooling and mixing. Such a process may provide a significant cost advantage in manufacturing.

In some embodiments, the compound(s)of structural Formula (I) are a mixture of cetyl alcohol and stearyl alcohol and the ionic compound is Ca(OH)₂. In one embodiment, the mixture of cetyl alcohol and stearyl alcohol is at about 80° C. when mixed with Ca(OH)₂. The bulk temperature of the mixture is kept below about 80° C. during mixing and the mixture including layered powder particles is cooled to a bulk temperature of less than about 42° C. In some of the above embodiments, the ratio of the mixture of stearyl alcohol and cetyl alcohol to Ca(OH)₂ is about 1:9. In other of the above embodiments, the mixture including layered powder particles is cooled to a bulk temperature of less than about 35° C. In still other of the above embodiments, the mixture including layered powder particles is cooled to a bulk temperature of less than about 25° C.

In other embodiments, the mixture of cetyl alcohol and stearyl alcohol is at about 75° C. when mixed with Ca(OH)₂. The bulk temperature of the mixture is kept below about 75° C. while mixing and the mixture including layered powder particles is cooled to a bulk temperature of less than about 42° C. In some of the above embodiments, the ratio of the mixture of stearyl alcohol and cetyl alcohol to Ca(OH)₂ is about 1:9. In other of the above embodiments, the mixture including layered powder particles is cooled to a bulk temperature of less than about 35° C. In still other of the above embodiments, the mixture including layered powder particles is cooled to a bulk temperature of less than about 25° C.

After the mixture has been cooled, some lumps of coated powder may be present. The lumps of coated powder may be broken up when an endpoint particle size is established according to procedures known to the skilled artisan (e.g., scalping through sieve, passing the powder through a rolling mill, etc.). Generally, the particle size of the layered powder should be about be greater than or equal to about 10 μM in diameter since particles with diameters smaller than about 10 μM may lead to processing problems. In some embodiments, the layered powder particles are between about 10 μM and about 300 μM in diameter. In other embodiments, the layered powder particles are between about 50 μM and about 300 μM in diameter. In still other embodiments, the layered powder particles are between about 50 μM and about 100 μM in diameter.

The present method may be used to provide production scale amounts of coated powder. In some embodiments, the volume of material mixed together (i.e., the volume of compound(s) of structural Formula (I) and the powder particles of ionic compound(s)) is greater than or equal to about 0.01 m³. In other embodiments, the volume of mixed material is between about 0.01 m³ and about 1.0 m³. In some other embodiments, the volume of mixed material is between about 1.0 m³ and about 10.0 m³. In still other embodiments the volume of mixed material is between about 10.0 m³ and about 100.0 m³.

Generally, the mixture including layered powder particles is not packaged or stored until the bulk temperature is less than about 15° C. above the glass transition point of the compound(s) since substantial oxidative degradation may occur above this temperature. In some embodiments, the bulk temperature of the mixture including layered powder particles is less than about 35° C. prior to packaging or storage. In other embodiments, the bulk temperature of the mixture including layered powder particles is less than about 25° C. prior to packaging or storage. Ideally, the mixture including powder particles is at ambient temperature prior to packaging or storage.

In some embodiments, the volume of the mixture including layered powder particles is greater than or equal to about 0.01 m³. In other embodiments, the volume of the mixture including layered powder particles is between about 0.01 m³ and about 1.0 m³. In some other embodiments, the volume of the mixture including layered powder particles is between about 1.0 m³ and about 10.0 m³. In still other embodiments the volume of the mixture including layered powder particles is between about 10.0 m³ and about 100.0 m³. In some of the above embodiments, the mixture including layered powder particles is packaged.

When a compound of structural Formula (I) is a fatty carboxylic acid or a fatty alcohol, oxidative degradation of the mixture including layered particles may be directly correlated with the amount of CO₂ in the packaged mixture. In general, a measured CO₂ level greater than about twice the atmospheric amount in a bulk packed cubic meter of the mixture including layered powdered particles indicates that the mixture was not sufficiently cooled and that spontaneous decomposition is occurring. Accordingly, the CO₂ level of the mixture including layered powder particles should be carefully monitored to ascertain if the mixture is spontaneously degrading.

### 5. EXAMPLES

The following example is provided by way of illustration only and not by way of limitation. Those of skill in the art will readily recognize a variety of noncritical parameters that could be changed or modified to yield essentially similar results.

5.1 Preparation of Cetyl Alcohol and Stearyl Alcohol Coated Powder

A jacketed reactor equipped with a low to moderate shear mixing device is charged with 9,000 lbs of Ca(OH)₂ and heat is applied while mixing until the temperature of the Ca(OH)₂ is about 80° C. One hundred pounds of cetyl alcohol and nine hundred pounds of stearyl alcohol are then added to the reactor and mixing is continued for between about 5 minutes and about 10 minutes. The appearance of the powder, when properly coated with the mixture of cetyl alcohol and stearyl alcohol, changes. The visual change may be due to an increase in reflectivity of the powder as a result of the coating of the particles with the mixture of cetyl alcohol and stearyl alcohol. The visual endpoint may be used by the skilled artisan to minimize the dwell time of the coated powder at elevated temperatures. The powder temperature during mixing stage is about 70° C. Additional heat is provided by jacket as necessary.

The finished powder is then released from the reactor onto a vibrating enclosed metal ramp so that the powder slowly slides in a thin layer to a holding bin. The ramp should be wide enough to empty the reactor in a few minutes to avoid decomposition of the coated powder in the reactor. Prior to deposition in the bin, the powder temperature is measured to ensure that it is less than the maximum safe packaging temperature, which for this particular powder is about 42° C. Various cooling methods, such as chilling the ramp with water or air, extending the length of the ramp or providing external cooling fins may be used as necessary to ensure that the temperature of the finished powder is at or below 42° C. The yield of coated powder is about 10,000 pounds of alcohol coated Ca(OH)₂. Finished powder may be packaged and/or transported, as required, from the holding bin.

Although the foregoing invention has been described in some detail by way of illustration and example for purposes of clarity of understanding, it will be readily apparent to one of ordinary skill in the art in light of the teachings of this invention that certain changes and modifications may be made thereto without departing from the spirit or scope of the appended claims.

All publications and patent applications cited in this specification are herein incorporated by reference in their entirety.

1. A method for making a coated powder suitable for dispersing onto the surface of a body of water as an evaporation suppressing monolayer, said method comprising
(a) mixing one or more compound(s) according to structural Formula (I):
R¹—Y (I)
at a temperature between about 30° C. above the glass transition point of the compound(s) and about 5° C. over the glass transition point of the compound(s) with powder particles of one or more ionic compound(s) so as to coat the powder particles with a layer of the compound(s) where the bulk temperature of the mixture is less than about 20° C. above the glass transition point of the compound(s); and
(b) cooling the layered powder particles to a bulk temperature of less than about 15° C. below the glass transition point of the compound(s), the bulk temperature of the layered particles being less than about 20° C. above the glass transition point of the compound(s) during steps (a) and (b);
wherein R¹ is (C₁₂-C₂₄) alkanyl; and
Y is selected from the group consisting of —OH, —C(O)H, —CONH₂, —CO₂H, —NH₂ and —S(O)₃H.

2. The method of claim 1 in which Y is selected from the group consisting of —OH, —CO₂H, —NH₂ and —S(O)₃H.

3. The method of claim 1 in which Y is —OH or —CO₂H.

4. The method of claim 1 in which R¹ is (C₁₆-C₂₀) alkanyl.

5. The method of claim 1 in which R¹ is CH₃(CH₂)₁₁—, CH₃(CH₂)₁₂—, CH₃(CH₂)₁₃—, CH₃(CH₂)₁₄—, CH₃(CH₂)₁₅—, CH₃(CH₂)₁₆—, CH₃(CH₂)₁₇—, CH₃(CH₂)₁₈—, CH₃(CH₂)₁₉—, CH₃(CH₂)₂₀— or CH₃(CH₂)₂₁—.

6. The method of claim 1 in which the powder particles are an alkaline earth hydroxide, Mg(OH)₂, Ca(OH)₂, Ba(OH)₂, acidified gypsum or mixtures thereof.

7. The method of claim 1 in which the powder particles are Ca(OH)₂ or acidified gypsum.

8. The method of claim 1 further comprising adding an extender material to the mixing in step (a).

9. The method of claim 8 in which the extender material is sand, microspheres or glass beads.

10. The method of claim 1 in which the layered powder particles are cooled to where the bulk temperature of the mixture is less than about 35° C.

11. The method of claim 1 in which the layered powder particles are cooled to where the bulk temperature of the mixture is less than about 25° C.

12. The method of claim 1 in which the temperature is between about 25° C. above the glass transition point of the compound(s) and about 5° C. over the glass transition point.

13. The method of claim 1 in which the temperature is between about 20° C. above the glass transition point of the compound(s) and about 5° C. over the glass transition point.

14. The method of claim 1 in which the volume of mixing in step (a) is greater than or equal to about 0.01 m³.

15. The method of claim 1 in which the volume of mixing is between about 0.01 m³ and about 1.0 m³, between about 1.0 m³ and about 10.0 m³ or between about 10.0 m³ and about 100.0 m³.

16. The method of claim 1 further comprising packaging the layered powder particles when the bulk temperature of the mixture is less than about 15° C. above the glass transition point.

17. The method of claim 1 further comprising packaging the layered powder particles when the bulk temperature of the mixture is less than about 35° C.

18. The method of claim 1 further comprising packaging the layered powder particles when the bulk temperature of the mixture is less than about 25° C.

19. The method of any one of claims 16-19 in which the volume of the layered powder particles is greater than or equal to about 0.01 m³

20. The method of claim 1 in which the volume of the layered powder particles is between about 0.01 m³ and about 1.0 m³, between about 1.0 m³ and about 10.0 m³ or between about 10.0 m³ and about 100.0 m³.

21. The method of claims 19 or 20 in which the partial pressure of CO₂ in the packaged layered powder particles is not greater than about twice the partial pressure of CO₂ in the atmosphere.

22. The method of claim 1 in which the cooling in step (b) takes place in less than about 60 minutes.

23. The method of claim 1 in which the mixing and cooling steps are continuous.

24. The method of claim 1 in which a fluidized bed is used for the mixing in step (a) and the cooling in step (b).

25. The method of claim 1 in which the time interval between the mixing in step (a) and the cooling in step (b) is less than about 60 minutes.

26. A method for making a coated powder suitable for dispersing onto the surface of a body of water as an evaporation suppressing monolayer, said method comprising
(a) mixing a mixture of about 9 parts of stearyl alcohol to about 1 part of cetyl alcohol on a weight by weight basis at about 80° C. with powder particles of Ca(OH)₂ so as to coat the powder particles with a layer of the mixture of stearyl alcohol and cetyl alcohol where the bulk temperature of the mixture is less than about 80° C.;
(b) cooling the layered powder particles to a bulk temperature of less than about 42° C.

27. A method for making a coated powder suitable for dispersing onto the surface of a body of water as an evaporation suppressing monolayer, said method comprising
(a) mixing a mixture of about 9 parts of stearyl alcohol to about 1 part of cetyl alcohol on a weight by weight basis at about 75° C. with powder particles of Ca(OH)₂ so as to coat the powder particles with a layer of the mixture of stearyl alcohol and cetyl alcohol where the bulk temperature of the mixture is less than about 75° C.;
(b) cooling the layered powder particles to a bulk temperature of less than about 42° C.

28. The method of claim 27 or claim 28 in which the ratio of the mixture of stearyl alcohol and cetyl alcohol to Ca(OH)₂ is about 1:9.

29. A coated powder suitable for dispersing onto the surface of a body of water as an evaporation suppressing monolayer, said powder made by a process comprising
(a) mixing one or more compound(s) according to structural Formula (I):
R¹—Y (I)
at a temperature between about 30° C. above the glass transition point of the compound(s) and
about 5° C. above the glass transition point with powder particles of one or more ionic compound(s) so as to coat the powder particles with a layer of the compound(s) where the bulk
temperature of the mixture is less than about 20° C. above the glass transition point; and
(b) cooling the layered powder particles to a bulk temperature of the mixture is less than about 15° C. below the glass transition point;
wherein R¹ and Y are as defined in claim 1.

30. A method of reducing evaporation on a body of water comprising application of an effective amount of the powder of claim 29 to the body of water.

31. A coated powder suitable for dispersing onto the surface of a body of water as an evaporation suppressing monolayer, said powder comprising a mixture of about 9 parts of stearyl alcohol to about 1 part of cetyl alcohol to about 90 parts of Ca(OH)₂ on a weight basis.
